(19) United States
(12) Patent Application Publication
(10) Pub. No.: US 2020/0294487 A1
(43) Pub. Date: Sep. 17, 2020

(54) HANDS-FREE ANNOTATIONS OF AUDIO TEXT

(71) Applicant: Ex-IQ, Inc., Dover, DE (US)

(72) Inventors: Christian Clarence Donohoe, Fayetteville, NC (US); Darren Ward, Stanwood, WA (US)

(21) Appl. No.: 16/500,373

(22) PCT Filed: Apr. 2, 2018
(86) PCT No.: PCT/US2018/025739

§ 371 Date: Oct. 2, 2019

Related U.S. Application Data
(60) Provisional application No. 62/633,489, filed on Feb. 21, 2018.
(60) Provisional application No. 62/481,030, filed on Apr. 3, 2017.

(51) Int. Cl. G10L 13/04; G10L 15/22; G10L 15/26

(52) U.S. Cl. CPC G10L 13/043; G10L 2015/223; G10L 15/265; G10L 15/22

(57) ABSTRACT

Embodiments enable a user to input voice commands for a system to read text, augment text with comments or formatting changes, or adjust the reading position. The user provides a command to read the text and a start position is determined. The audio reading of the text at that position is output to the user. As the user is listening to the reading of the text, the user provides additional voice commands to interact with the text. For example, the user provides commands to provide comments, and the system records the comments provided by the user and associates them with the current reading position in the text. The user provides other commands to format the text, and the system modifies format characteristics of the text. The user provides yet other commands to modify the current reading position in the text, and the system adjusts the current reading position accordingly.

### TECHNICAL FIELD

The present disclosure relates generally to audio text, and more particularly, but not exclusively, to providing hands-free annotations of audio text.

### BACKGROUND

The development and advancement of tablet computers have given people more flexibility in how, when, and where they read books, newspapers, articles, journals, and other types of text documents. However, there are many situations where people cannot devote the time to visually read these types of writings. As a result, audio text, such as audio books, has been one option to allow people to consume written text documents when they are unable to use their eyes to read such documents. However, the ability for the person to interact with such audio text documents has been rather limited. It is with respect to these and other considerations that the embodiments herein have been made.

### BRIEF SUMMARY

For many people, going to college can be a daunting task, especially for those who have been in the work force for many years. Oftentimes, these people keep their day jobs and attend classes at night. As a result, most of their day is consumed with work and school, and maybe some family time. This heavy schedule is magnified when homework is introduced into the equation. So, people have to find time to study around work and classes, not to mention all the time commuting between home, work, and school. Embodiments described herein provide for a hands-free system that enables a user to listen to homework assignments, or other text, and augment that text as if they were sitting down reading a physical book.

The system includes a speaker to output audio signals to a user and a microphone to receive audio signals from the user. The system also includes a processor that executes instructions to enable a user to input a voice command for the system to read text, augment the text with comments or formatting changes, or to adjust the current reading position in the text.

For example, the system receives, via the microphone, a first voice command from a user to read the text. A start position for reading the text is determined and an audio reading of the text beginning at the start position is output, via the speaker, to the user. As the user is listening to the reading of the text, the user provides additional voice commands to interact with the text. In some embodiments, the system receives, via the microphone, a second voice command from the user to provide a comment. The system then records, via the microphone, the comment provided by the user at a current reading position in the text. In other embodiments, the system receives, via the microphone, a third voice command from the user to format the text. The system then modifies at least one format characteristic of at least a portion of the text based on the third voice command received from the user. In yet other embodiments, the system receives, via the microphone, a fourth voice command from the user to modify the current reading position in the text. The system can then output, via the speaker, the audio reading of the text to the user from the modified reading position.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present disclosure, reference will be made to the following Detailed Description, which is to be read in association with the accompanying drawings:

FIG. 1 illustrates an example environment of a user utilizing an interactive reading system described herein;

FIG. 2 illustrates a context diagram of an example interactive reading system described herein;

FIG. 3 illustrates a logical flow diagram generally showing an embodiment of a process for enabling a user to interact with audio text described herein;

FIG. 4 illustrates a context diagram of an alternative example an interactive reading system described herein;

FIG. 5 illustrates a logical flow diagram generally showing an embodiment of a process for an interactive audio server to generate a notes table based on user interactions while listening to audio text described herein;

FIG. 6 illustrates a context diagram of yet another example an interactive reading system described herein;

FIGS. 7A-7B illustrate logical flow diagram generally showing embodiments of processes for an interactive audio device and an interactive audio server to generate a notes table based on user input during a live audio recording described herein;

FIGS. 8A-8B illustrate logical flow diagram generally showing an alternative embodiment of processes for an interactive audio device and an interactive audio server to generate a notes table based on user input while listening to a previously recorded audio file described herein;

FIG. 9 shows a system diagram that describes one implementation of computing systems for implementing embodiments of an interactive audio device described herein; and

FIG. 10 shows a system diagram that describes one implementation of computing systems for implementing embodiments of an interactive audio server described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

References herein to “text” refer to content, documents, or other writings that include written text that can be visually read by a person. References herein to “audio text” refer to an audio version of the text. In some embodiments, audio text may include an audio file or recording of a person reading the written text. In other embodiments, audio text may include a machine reading of the written text that outputs an audio version of the written text.

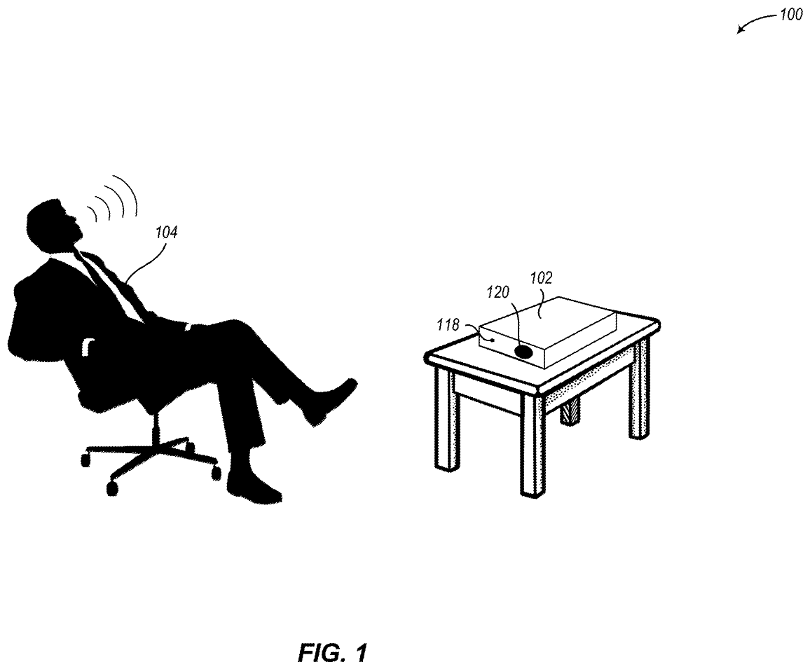

FIG. 1 illustrates an example environment of a user utilizing an interactive reading system in accordance with embodiments described herein. Example 100 includes a user 104 and an interactive audio device 102. In this example, the user 104 is utilizing the interactive audio device 102 to listen to audio text while sitting in the user's living room. However, embodiments are not so limited and the user can utilize the interactive audio device 102 to listen to audio text driving in a car, riding on a train, walking down the street, or while performing other activities.

Embodiments of the interactive audio device 102 are described in more detail below, but briefly the interactive audio device 102 includes a microphone 118 and a speaker 120. The interactive audio device 102 is a computing device such as a smart phone, tablet computer, laptop computer, desktop computer, automobile head unit, stereo system, or other computing device. The user 104 verbally states voice commands that are picked up by the microphone 118 and the interactive audio device 102 performs some action based on those voice commands. For example, the user 104 can instruct the interactive audio device 102 to being reading a book or other text, which it outputs via the speaker 120. Other voice commands can include, but are not limited to, changing the reading position within the text, recording a comment to add to the text, highlighting the text, or other modifications or augmentations to the text. By employing embodiments described herein, the user can interact with and augment the text via spoken words without having to use their hands to manually take down notes or highlight the text.

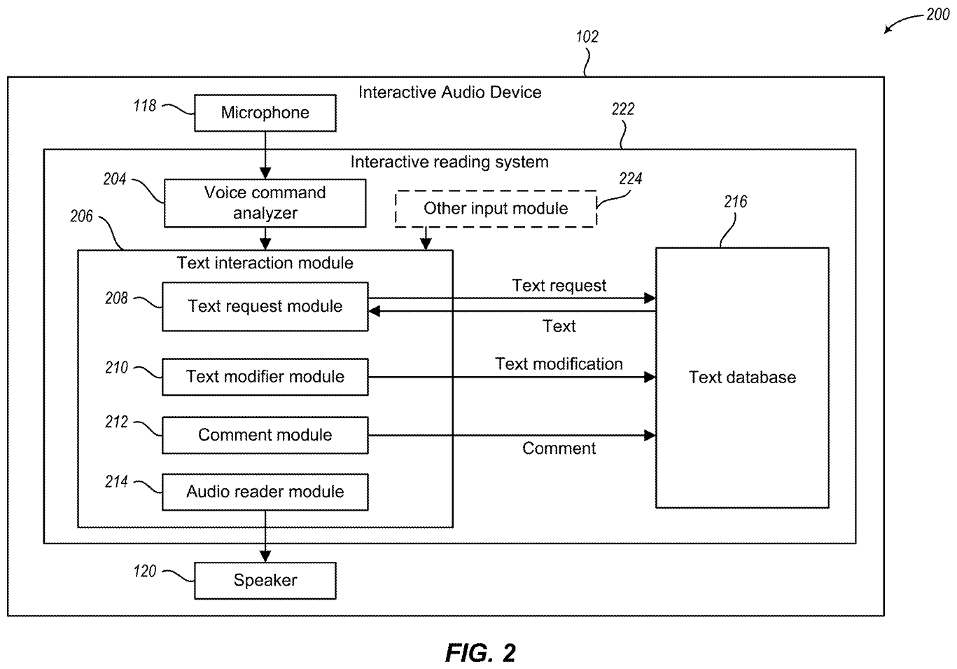

FIG. 2 illustrates a context diagram of an example interactive reading system in accordance with embodiments described herein. System 200 includes an interactive audio device 102. The interactive audio device 102 is a computing device such as a smart phone, tablet computer, laptop computer, desktop computer, automobile head unit, stereo system, or other computing device. A user may utilize the interactive audio device to listen to audio text in a car, on a train, while walking, or while performing other activities.

In this illustrative example, the interactive audio device 102 includes a microphone 118, a speaker 120, and an interactive reading system 222. The microphone 118 is structured and configured to capture audio signals provided by a user. The speaker 120 is structured and configured to output audio signals to the user. Although FIG. 2 illustrates the microphone 118 and the speaker 120 as being part of the interactive audio device 102, embodiments are not so limited. In other embodiments, the microphone 118 or the speaker 120, or both, may be separate from the interactive audio device 102. For example, the microphone 118 and the speaker 120 may be integrated into a headset, headphones, a mobile audio system, or other device. These devices can communicate with the interactive audio device 102 via a wireless connection, such as Bluetooth, or a wired connection.

The interactive reading system 222 includes a voice command analyzer 204, a text interaction module 206, and a text database 216. The text database 216 is a data store of one or more text documents or files, such as audio books, audio files of readings of books, text that can be machine read, etc. The text database 216 may also store comments associated with the text or other augmentations provided by the user, as described herein. Although the text database 216 is illustrated as being integrated into the interactive audio device 102, embodiments are not so limited. For example, in other embodiments, the text database 216 may be stored on a remote server that is accessible via the Internet or other network connection.

The voice command analyzer 204 analyzes audio signals captured by microphone 118 for voice commands provided by the user. Those commands are input into the text interaction module 206, where they are processed so that the user can listen to, interact with, and augment text. The text interaction module 206 may employ one or more modules to implement embodiments described herein. In this illustration the text interaction module 206 includes a text request module 208, a text modifier module 210, a comment module 212, and an audio reader module 214. In various embodiments, the functionality of each of these modules may be implemented by a single module or a plurality of modules, but their functionality is described separately for ease of discussion.

The text request module 208 interacts with text database 216 to request and receive text for a user. For example, the user can input a command for the system 200 to read a book. This command is received by the microphone 118 and provided to the voice command analyzer 204. The voice command analyzer 204 provides this read command to the text request module 208, which then retrieves the corresponding text from the text database 216. In some embodiments, the text request module 208 may interact with multiple documents or other applications to determine the specific text to retrieve from the text database 216. For example, a user command may be “read today's assignment for Civics 101.” The text request module 208 accesses the syllabus for Civics 101, which may be stored in the text database 216 or on a remote server that is accessible via the internet or other network connection. The text request module 208 can then utilize the syllabus to determine the text that corresponds to “today's assignment” and retrieve it from the text database 216.

The audio reader module 214 coordinates with the text request module 208 to receive the retrieved text. The audio reader module 214 then processes the text to be read to the user. In some embodiments, where the text includes an audio file of a person reading the text, the audio reader module 214 provides an audio stream from the audio file to the speaker 120 for output to the user. In other embodiments, the audio reader module 214 performs machine reading on the text and provides the resulting audio steam to the speaker 120 for output to the user.

As mentioned herein, the user can provide voice commands to interact with the text being read. For example, the user can tell the system 200 to reread the last sentence or skip to a specific chapter in a book. These types of reading position changes are received by the audio reader module 214 from the voice command analyzer 204. The audio reader module 214 then adjusts the reading position accordingly and reads the text from the adjusted position. In some embodiments, the audio reader module 214 may interact with the text request module 208 to obtain additional text if the originally retrieved text does not include text associated with the modified reading position.

The user can also provide voice commands to format or otherwise modify the text. For example, the user can tell the system 200 to highlight the last sentence. These types of formatting commands are received by the text modifier module 210 from the voice command analyzer 204. The text modifier module 210 can then directly modify the text with the corresponding format changes, which are then stored on the text database 216, or the text modifier module 210 can store the format changes in the text database 216 as augmentations or metadata associated with the text.

Moreover, the user can provide voice commands to record a comment provided by the user. For example, the user can tell the system 200 to record a comment and then state the comment. The comment module 212 coordinates the receipt of the comment with the voice command analyzer 204 and coordinates the storage of the received comment with the text database 216. In various embodiments, the comment module 212 also obtains the current reading position in the text from the audio reader module 214, so that the comment is stored with the current reading position in the text. In some embodiments, the comment module 212 converts the audio comment received from the user into a textual comment to be stored with the original text.

In some embodiments, the interactive reading system 222 optionally includes another input module 224, which can receive manual inputs and commands from the user. For example, the other input module 224 can receive graphical user interface commands to format the text or to adjust the reading position in the text.

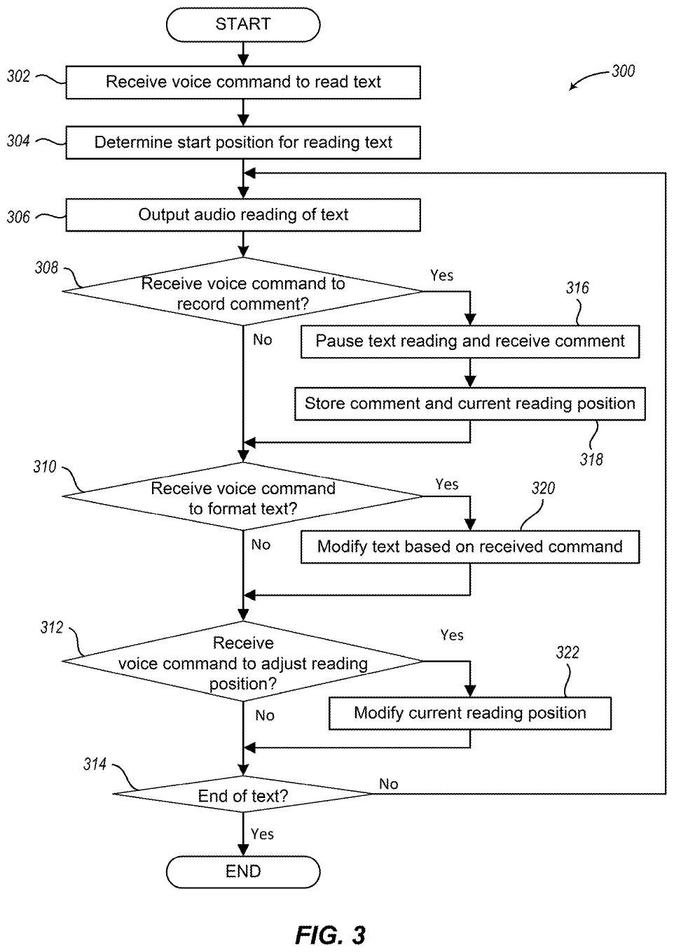

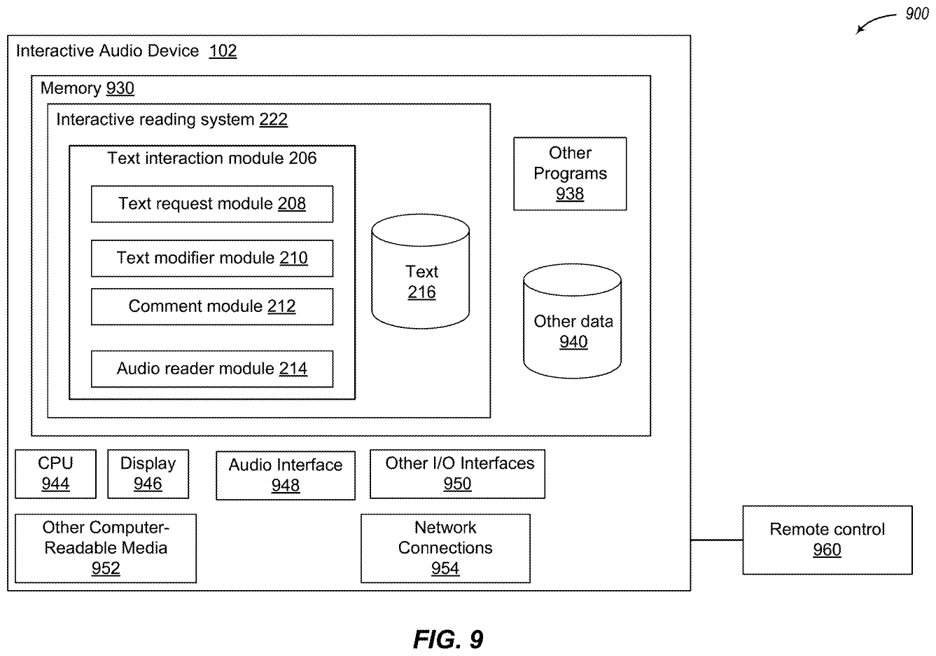

The operation of certain aspects will now be described with respect to FIG. 3. In at least one of various embodiments, process 300 may be implemented by or executed on one or more computing devices, such as interactive audio device 900 described in FIG. 9 below.

FIG. 3 illustrates a logical flow diagram generally showing one embodiment of a process for enabling a user to interact with audio text in accordance with embodiments described herein.

Process 300 begins, after a start block, at block 302, where a voice command is received to read text. In various embodiments, this command is an audible command provided by a user that desires to have audio text read to the user. In some embodiments, the command may include a name or identification of the text to be read. For example, the voice command may be “read To Kill A Mockingbird.”

Process 300 proceeds to block 304, where a start position is determined for reading the text. In some embodiments, the voice command received at block 302 may include a starting page, line, or paragraph, e.g., “start To Kill A Mockingbird at chapter 5.” In other embodiments, the system may store a last read position in the text. In this way, the system can start providing audio of the text at the last read position without the user having to remember where it should start.

In yet other embodiments, other text may be used to identify the text and determine the starting position. For example, in some embodiments, the prompt received at block 302 may be “read today's assignment for Civics 101.” In such an embodiment, the system accesses a syllabus for the Civics 101 class, and based on the current date, selects the text and starting location that corresponds to the day's assignment. The day's assignment may be determined based on machine text recognition techniques or via tags that include links to the particular text associated with the day's assignment.

Process 300 continues at block 306, where an audio reading of the text is output to the user. In some embodiments, this audio reading may be the playing of an audio file of a person reading the text. In other embodiments, the audio reading may be a machine reading of the written text.

Process 300 proceeds next to decision block 308, where a determination is made whether a voice command is received to record a comment. Similar to block 302, the user may verbally state a particular phrase that instructs the system to begin recording a user's comment. For example, the user could say “record comment.” If a command to record a comment is received, process 300 proceeds to block 316; otherwise, process 300 flows to decision block 310.

At block 316, the text reading is paused and an audio recording of the user talking is received. As mentioned above, the comment may be received via a microphone. In various embodiments, a current reading position within the text is determined and at least temporarily stored.

Process 300 continues next at block 318, where the comment is stored along with the current reading position in the text. In some embodiments, the text itself may be modified with the comment. For example, audio text recognition techniques may be utilized to convert the user's audible words into written text, which may be inserted into the written text, added as a comment box in a margin of the text, or otherwise associated with the current reading position. In some embodiments, the audio recording may be embedded into the text such that a user could later click on the audio file or a link thereto to hear the comment. After block 318, process 300 proceeds to decision block 310.

If, at decision block 308, a voice command to record a comment is not received, process 300 flows from decision block 308 to decision block 310. At block 310, a determination is made whether a voice command is received to format the text. Similar to decision block 308, a user may verbally state a particular phrase to modify one or more formatting characteristics of the text. Tables 1 and 2 below are example voice commands and the corresponding formatting.

TABLE 1

| Voice Command | Text formatting |
|---|---|
| “underline 1” or | Underline or highlight the previous sentence |
| “highlight 1” | that was read to the user. |
| “underline 2” or | Underline or highlight the previous 5 words. |
| “highlight 2” | |
| “underline 3” or | Underline or highlight the previous 10 words. |
| highlight 3” | |
| “highlight 4” | Highlight the previous word or phrase |
| | throughout all of the text. |

TABLE 2

| Voice Command | Text formatting |
|---|---|
| “underline sentence” or | Underline the previous sentence that was read |
| “highlight sentence” | to the user. |
| “underline x” or “ | Underline or highlight the previous x number |
| highlight x”, where x is | of words. |
| an integer | |
| “highlight all” | Highlight the previous word or phrase |
| | throughout all of the text. |

The above examples are for illustrative purposes and should not be considered limiting or exhaustive and other types of commands or formatting could be utilized. For example, the text formatting may include, underline, italicize, bold, highlight, or other textual formatting.

In other embodiments, the user can input other modifications to the text. For example, in some embodiments, the user can provide a voice command to add a tag, tab, or bookmark at the current reading position. In this way, the current reading position can be easily accessed at a later date.

If a command to format the text is received, process 300 proceeds to block 320; otherwise, process 300 flows to decision block 312. At block 320, the text is modified based on the received formatting command. In some embodiments, the actual text is modified to include the indicated formatting. In other embodiments, annotations or metadata may be utilized to store the indicated formatting separate from the original text. Such annotations or metadata can be used to later display the text to the user as if the text was formatted. In this way the original text is not modified, but can be displayed as if it was modified by the user.

In some embodiments, the system can automatically adjust the formatting to be distinguishable from the text. For example, if the text is already italicized and the user provides a command to italicize the text, the system can change the formatting to be underlined or some other formatting change that is different from the original text. After block 320, process 300 flows to decision block 312.

As mentioned above, the user can provide a command to add a tag, tab, or bookmark to the text. In various embodiments, the metadata may be modified to include the appropriate tag, tab, or bookmark. These tags, tabs, or bookmarks may be visually present when the text is displayed to the user. Similarly, the tag, tab, or bookmark may be made audible to the user during the reading of the text.

If, at decision block 310, a voice command to format the text is not received, process 300 flows from decision block 310 to decision block 312. At block 312, a determination is made whether a voice command is received to adjust the current reading position. In various embodiments, a user may verbally state a particular phrase to change the current reading position in the text. Tables 3 and 4 illustrate various examples of such commands.

TABLE 3

| Voice Command | Change in reading position |
|---|---|
| “reread sentence” | Adjust reading position to the beginning of the |
| | previous sentence. |
| “go to next chapter” | Adjust reading position to the beginning of the |
| | next chapter after the currently read chapter. |
| “back x,” where | Adjust reading position to start x number of |
| x is an integer” | words that precede current reading position. |
| “tag next” | Adjust reading position to position of next user- |
| | defined tag. |

TABLE 4

| Voice Command | Change in reading position |
|---|---|
| “back 1” | Adjust reading position to the beginning of the |
| | previous sentence. |
| “back 2” | Adjust reading position to start 5 words before |
| | the current reading position. |
| “back 3” | Adjust reading position to start 10 words before |
| | the current reading position. |
| “forward 1” | Adjust reading position to the beginning of the |
| | next chapter after the currently read chapter. |

The above examples are for illustrative purposes and should not be considered limiting or exhaustive and other types of reading position commands may be utilized.

In some embodiments, the action associated with one command may be based on a previous command. For example, if a user states “back 20” to reread the previous 20 words, the user can then state “highlight” to highlight those words that have been reread. In this way, the user can quickly highlight text that was reread without having to remember how many words were reread.

If a command to adjust the current reading position is received, process 300 proceeds to block 322; otherwise, process 300 flows to decision block 314. At block 322, the current reading position is modified to the position in the text associated with the received command. After block 322, process 300 flows to decision block 314.

If, at decision block 312, a voice command to adjust the current reading position is not received, process 300 proceeds from decision block 312 to decision block 314. At decision block 314, a determination is made whether the reading has reached the end of the text. In some embodiments, the end of the text may be the end of the text writing. In other embodiments, the end of the text may be based on input from the user or from another document. For example, in block 302, the user may state, “read chapter 5 in To Kill a Mockingbird.” In this example, the end of text is reached when the reading position reaches the end of chapter 5. In another example, in block 302, the user may state, “read today's Civics 101 assignment.” As mentioned above, a syllabus for the class can be used to determine the text and start position for reading the text. In a similarly way, the end position may be determined. For example, if the syllabus indicates “read pages 34-52 in Book A” then the end of the text may be the bottom of page 52, even though there may be 400 pages in Book A.

If the current reading position has reached the end of the text, then process 300 terminates or otherwise returns to a calling process to perform other actions; otherwise, process 300 loops to block 306 to continue outputting the audio reading of the text.

Although process 300 is described as receiving voice commands, manual commands from the user may be used instead or in combination with the voice commands. For example, in some embodiments, the user may utilize buttons or icons in a graphical user interface of the interactive audio device to click on or select the text that is to be read, e.g., at block 302, or to perform another action, such as to input a comment, modify the text formatting, or adjust the current reading position. In other embodiments, gestures or simple user interface movements on the graphical user interface may be utilized to manually input a command. For example, the user may a swipe their finger across a touch screen to input a comment, or the user may a slide their finger over the touch screen in the shape of a number, letter, or other character, such as in the shape of a “5” to highlight the last five words or in the shape of a “p” to reread the previous paragraph.

Other types of voice or manual commands may be provided to the system to interact with an audible reading or annotate the text being read. For example, in other embodiments, the system may include a remote control that communicates with the interactive audio device to enable the user to input various commands via physical buttons on the remote control. Each button on the remote control corresponds to a different command to interact with the audio text, such as input a comment, modify the text formatting, or adjust the current reading position. The remote control and interactive audio device communicate via a wired or wireless connection.

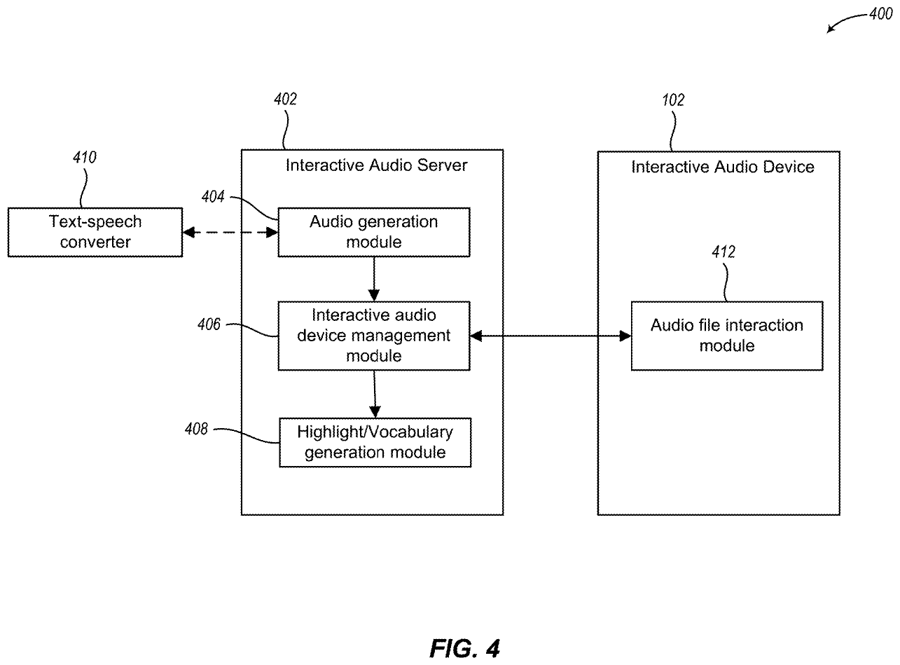

FIG. 4 illustrates a context diagram of an alternative example an interactive reading system described herein. System 400 includes an interactive audio server 402, an interactive audio device 102, and optionally a text-speech converter 410. The interactive audio server 402 includes one or more computing devices, such as a server computer, a cloud-based server, or other computing environment. The interactive audio device 102 is a computing device of a user that is augmenting audio text or generating extracted text files while listening to audio text, as described herein.

The interactive audio device 102 includes an audio file interaction module 412. The audio file interaction module 412 enables a user to select a book or text file to listen to. The audio file interaction module 412 communicates with the interactive audio server 402 to receive an audio file of a book and play it for the user. The audio file interaction module 412 also allows the user to trigger events to extract highlighted text or vocabulary text, as described herein. Moreover, the audio file interaction module 412 communicates with the interactive audio server 402 to enable the user to access the extracted highlighted text or vocabulary text as part of an augmented version of the original text file or as a separate notes table or file. Interactive audio server 402 includes an audio generation module 404, an interactive audio device management module 406, and a highlight/vocabulary generation module 408. The audio generation module 404 manages the extraction of plain text from a text file and converts it to an audio file. In some embodiments, the audio generation module 404 itself performs text to speech processing. In other embodiments, the audio generation module 404 communicates with an external text-speech converter 410. The text-speech converter 410 may be a third party computing system that receives a text file and returns an audio file. The interactive audio device management module 406 communicates with the interactive audio device 102 to provide the audio file to the interactive audio device 102 and to receive information regarding events (e.g., highlight events or vocabulary events and their event time position) identified by the user of the interactive audio device 102 while listening to the audio file.

The interactive audio device management module 406 provides the received events to the highlight/vocabulary generation module 408. The highlight/vocabulary generation module 408 uses a speech marks file associated with the audio file to extract text associated with the identified events. The extracted text is then added to a notes table or file that is separate from the text file that was converted to the audio file for listening by the user. The interactive audio device management module 406 or the highlight/vocabulary generation module 408 also provides to the interactive audio device 102 access to the notes table or file.

Although FIG. 4 illustrates the interactive audio server 402 as including multiple modules, some embodiments may include one, two, or more, or some combination of modules to perform the functions of the interactive audio server 402. Similarly, although the interactive audio device 102 is illustrated as having a single module, some embodiments may include a plurality of modules to perform the functions of the interactive audio device 102.

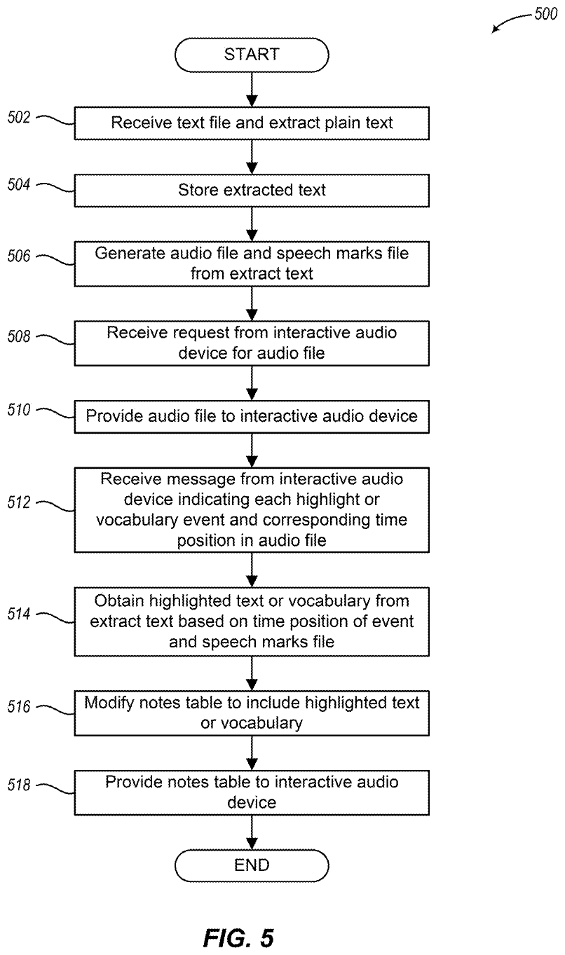

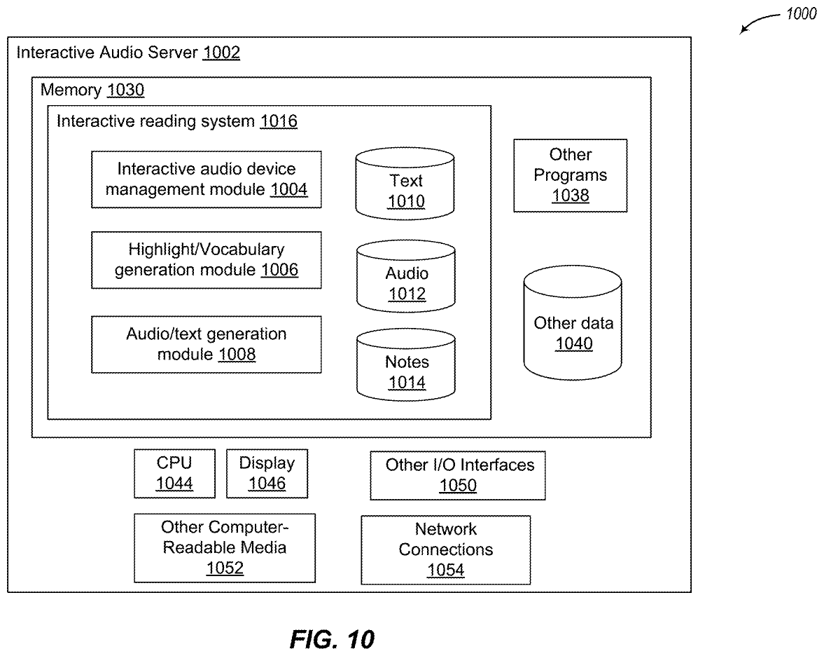

The operation of certain aspects will now be described with respect to FIG. 5. In at least one of various embodiments, process 500 may be implemented by or executed on one or more computing devices, such as interactive audio server 402 in FIG. 4 or interactive audio server 1000 described in FIG. 10 below.

FIG. 5 illustrates a logical flow diagram generally showing an embodiment of a process for an interactive audio server to generate a notes table based on user interactions while listening to audio text described herein. In general, to know what sentence the user wants to highlight or which vocabulary word to identify while listening to a book with an audio text presentation application, the current reading location in the book is tracked, so the system can highlight and copy the sentence(s) or vocabulary in which the user was listening.

Process 500 begins, after a start block, at block 502, where a text file is received and plain text is extracted therefrom. In various embodiments, the text file is an electronic text version of a book, paper, news article, or other writing. In some embodiments, the text file may be uploaded by an administrator, professor, instructor, the user, or other entity. The text file may be a PDF document, DOC document, DOCX document, TXT document, or a document of other textual formats. When the text file is uploaded to the interactive audio server, all the text from the text file is extracted.

Once the text file is uploaded to the interactive audio server, plain text is extracted therefrom. The interactive audio server performs several steps to extract plain text from the text file and eliminate text that is not conducive to listening in audio book format. For example, the interactive audio server scans the text to identify a title page, header and footer text, page numbers, registration and copyright page, table of contents page(s), acknowledgements page(s), list of abbreviations page, list of figures page(s), index page(s), vertical text, text boxes or quote boxes, reference text (usually found at bottom of each page or at the end of a document), reference marks (usually a superscript number at the end of a word), any occurrence of a table in the document, any occurrence of a figure and its label, and any occurrence of text and numbers within a parentheses. If the interactive audio server identifies any of these types of content in the text file, the interactive audio server may remove it from the extracted text or ignore this content when extracting the remaining text. In an embodiment, replacement text may be inserted into the extracted text by the interactive audio server when text is removed (e.g., “Table 2A Removed”, “See FIG. 1”, etc.).

The interactive audio server scans the extracted text for occurrences of titles, chapter names, section headers, etc. and adds appropriate punctuation. The addition of punctuation reduces the chances of the machine generated (artificial intelligence) voice having run-on sentences when converting to audio.

The interactive audio server then employs known text parsing (e.g., using a list of known words, phases, and grammar) and additional text classifier algorithms and machine learning to continuously train the text scanning models to detect charts, lists, references, etc. to not include in the extracted text. This helps the system find new patterns of text that may be removed from the extracted text for audible reading, which can be beneficial for identifying technical journals, specialized text books, or other materials that contain non-conversational or technical text or language.

Process 500 proceeds to block 504, where the extract text is stored for later processing to generate highlighted text or vocabulary text. After the parsing and machine learning processing is performed on the extracted text, the remaining extracted text is stored so that it can be provided to a text-to-speech processing unit to generate an audio version of the extracted text.

Process 500 continues at block 506, where an audio file and speech marks file is generated from the extracted text. In various embodiments, the extracted text is converted into an audio file utilizing text-to-speech conversion processing.

In some embodiments, this processing is performed by the interactive audio device. In other embodiments, the interactive audio device employs a third party web service to generate the audio file using Text to Speech processing. While the audio file is being generated, a speech marks file is also generated to help to synchronize the extracted text with the audio in the audio file. In at least one embodiment, the speech marks file includes a mapping between the time position of specific sentences or words or phrases in the audio file and the corresponding sentences, words, or phrase, or a mapping between the time position of specific sentences or words or phrases in the audio file and a text location of the corresponding sentences, words, or phrases in the extract text file.

Process 500 proceeds next to block 508, where the interactive audio server receives a request from a user's interactive audio device for the audio file. In some embodiments, the request is for the entire audio file, a portion of the audio file, or for the audio file to be streamed to the interactive audio device.

In some embodiments, the interactive audio server may provide a notification to the interactive audio device to update the interactive audio device to indicate that the corresponding audio file associated with the received text file (e.g., an audio book) is available to listen to on the interactive audio device. The user can then input a request to start listening to the audio file.

Process 500 continues next at block 510, where the audio file is provided to the interactive audio device. In various embodiments, the entire audio file or a portion of the audio file, or the audio file is streamed to the interactive audio device based on the request.

While the user is listening to the book, if they hear information, words, or a topic that they want to remember or use for studying later, they can simply input a command to create an event. The event can be one of many different options, such as a highlight event or a vocabulary event. A highlight event indicates one or more words, one or more sentences, or one or more paragraphs to highlight and obtain for a notes table. And a vocabulary event identifies a particular word that the user wants to specifically add to the notes table because they may be unfamiliar with the word or it is a word of importance.

With regards to a highlight event, the user can tap a highlight button on the screen of the interactive audio device. The length of time pressing the button or the number of times pressing the button can be used to indicate how much text to highlight. For example, pressing the highlight button once during playback may default to highlighting the current sentence when the highlight was initially triggered and the sentence before, whereas pressing the highlight button two time will highlight an additional one sentence or pressing the highlight button three or four or five times will highlight additional sentences based on the number of times the highlight button is pushed.

Although described as the user pushing a button to initiate the highlighting, the user may also provide a verbal command to initiate the highlighting, as described herein. For example, the user can say/speak “highlight” during playback, which commands the system to highlight x number of sentence. In some embodiments, the system may default to highlighting two sentences or some other user or administrator defined number of sentences. Alternatively, the user can specify the number of sentences to highlight, by saying “Highlight 3” or “Highlight 4” to highlight the previous three sentences (or the current sentence and the previous two sentences) or the previous four additional sentences (or the current sentence and the previous three sentences). Although described as highlighting sentences, similar techniques may be utilized to highlight words or paragraphs.

In some embodiments, once the highlight button is pushed, playback of the book is paused and the time location of the highlight event in the audio is determined. The interactive audio device may then confirm to the user that they want to highlight x number of sentences (based on their pushing of the highlight button). User can then click a button to confirm the highlights. In some embodiments, the pausing of the playback and highlight confirmation may be optional and may not be performed.

With regards to a vocabulary event, the user can push an “add vocabulary” button or audibly speak an “add vocabulary” instruction. The time in the audio text when the add vocabulary command is determined. In various embodiments, the user may specify the vocabulary word in the audible instruction. For example, the user can say “Add {word} to Vocabulary file,” where {word} is desired vocabulary word to extract. In various embodiments, the interactive audio device may pause playback, and convert the user-provided speech to text to identify the vocabulary word (and the event time). In some embodiments, the interactive audio device may send a recording of the user-provided speech, such that the interactive audio device performs the text recognition to determine the vocabulary word. In an embodiment, the interactive audio device may prompt the user to confirm the text version of the word to add. Once confirmed, the interactive audio device resumes playback and provides the word and the event time in the audio text to the interactive audio server, as discussed below.

In some embodiments, the interactive audio device can also prompt the user to ‘tag’ the event (whether a highlight event or a vocabulary event) with a category or some other type of identifier. For example, the user can identify a particular category associated with an event, which can be used later to filter notes collected from this and other books. Such categories may include, but are not limited to definition, background, important, equation, etc. These categories as merely examples and could be default or defined by the user and other types of categories may also be used. For example, law students may define categories for briefing cases, which may include issue, facts, plaintiff, defendant, holding, dicta, etc. Once user confirms the tag, the interactive audio device also allows the user to dictate additional notes in their own words to be added to the highlighted/vocabulary/extracted text in the notes file. If the user chooses to add a dictation note, the microphone on the interactive audio device is turned on and the user's audible speech is recorded. Process 500 proceeds to block 512, where a message is received from the interactive audio device indicating one or more highlight or vocabulary events identified by the user. As mentioned herein, the user may input a highlight or vocabulary command via voice commands or manual commands. The message includes an indication of the type of event (highlight or vocabulary) and the corresponding time position of the event in the audio file. In some embodiments, the interactive audio device may provide this message as each event occurs. In other embodiments, the interactive audio device may provide the message after a plurality of events have occurred or after the user has stopped or completed listening to the audio file.

The message received from the interactive audio device regarding the events identified by the user may include various information, including the text file or book name/identifier, book page number, book chapter, time code (i.e., the event time position) in the audio file, and specific details regarding the event. In some embodiments, the specific details regarding the event may include the number of sentences to highlight, the vocabulary word, or user-provided speech of the vocabulary word, etc. The message may also include any tags or extracted text from dictation, if provided. This message may be sent for a single event, such that each separate message is for a separate event, or the message may include information for a plurality of events.

In various embodiments, dictation or user-provided speech is sent to a speech to text processing module on the interactive audio server to convert to the dictation note into text. In some embodiments, the dictation note may be sent back to the interactive audio device or stored to be later combined with the highlighted text or vocabulary text.

Process 500 continues to block 514, where highlighted text or vocabulary text is obtained from the extracted text based on the time position of each event and the speech marks file. For example, the interactive audio server use the speech marks file and its mappings along with the event time position to obtain the specific sentence in the text file associated with the event. Using the number of sentences the user indicated they wanted highlighted, additional sentences prior to the specific sentence associated with the event time position are also obtained.

For example, when a user tells the tool to highlight the last sentence, the interactive audio server extracts text from the text file (e.g., the book), including the text that was removed for preparing the audio version, to be saved in the associated notes file. Even if some reference text was not read back to the user (because it was removed for processing the text to audio at block 502), that reference text is included in the extracted notes along with the other text that was read back to the user.

For a vocabulary event, the interactive audio server searches the text file of the book using the speech marks file near the position the command was given (i.e., the event time) for the vocabulary word. Once the word is located within a predetermined time distance or word distance from the event time position, a bookmark may be added to the extract text or the original text file. In some embodiments, a predetermined amount of text from the text file associated with the position of the vocabulary word is extracted.

Process 500 proceeds next to block 516, where a notes table is created or modified to include the highlighted text or vocabulary text. The interactive audio server then creates or adds a record to a notes table in a database of recorded notes for the user of the interactive audio device. In various embodiments, the new record contains the user ID, book ID, page number, chapter, date & time, the complete wording that was from the book that was obtained as being highlighted, the specific vocabulary word (and in some embodiments, the corresponding sentence associated with the vocabulary word), etc.

In some embodiments, the new record may also include the event time position or a start and stop time or text position. For example, the new record may include the starting position in the text file/speech marks file to start highlighting and the end position to stop, which can be used by the file viewer to identify the correct number of highlighted sentences. In some embodiments, the vocabulary word is added to the note file/database in the interactive audio server with a link back to the corresponding bookmark position in the text version of the original text file of the book.

In various embodiments, a single notes table or file is created for all events. In other embodiments, a separate notes table or file is created for different types of events. For example, one notes table may include highlighted text and a separate notes table may include vocabulary text. Even if all events are included in a single notes table, the events may be sorted by event time position, type of event, user tag, etc. Although described as a table other files or data structures may be used for the notes

In various embodiments, the original text may be augmented, as described above, to modify the text based on the received event. For example, the text in the text version that corresponding to a highlight event may modify the format of the text to be highlighted, as discussed herein. In this way, the entire text may be provided to the user with format changes that match the user's event input, as described above.

Process 500 continues next to block 518, where the notes table is provided to the interactive audio device for display or access by the user. In some embodiments, the notes table may be provided to the interactive audio device in response to a request from the interactive audio device or automatically after the user has finished listening to the audio file. Accordingly, after the user has completed listening to the book or at other times, the user can request to view previously recorded vocabulary items.

By storing the records in a notes table that is separate from the original text file or audio file of the book, the user can review, filter, or search through the highlighted and extracted text independent of the original text, which can allow the user to more efficiently create, store, and recall important details about the book.

After block 518, process 500 terminates or otherwise returns to a calling process to perform other actions.

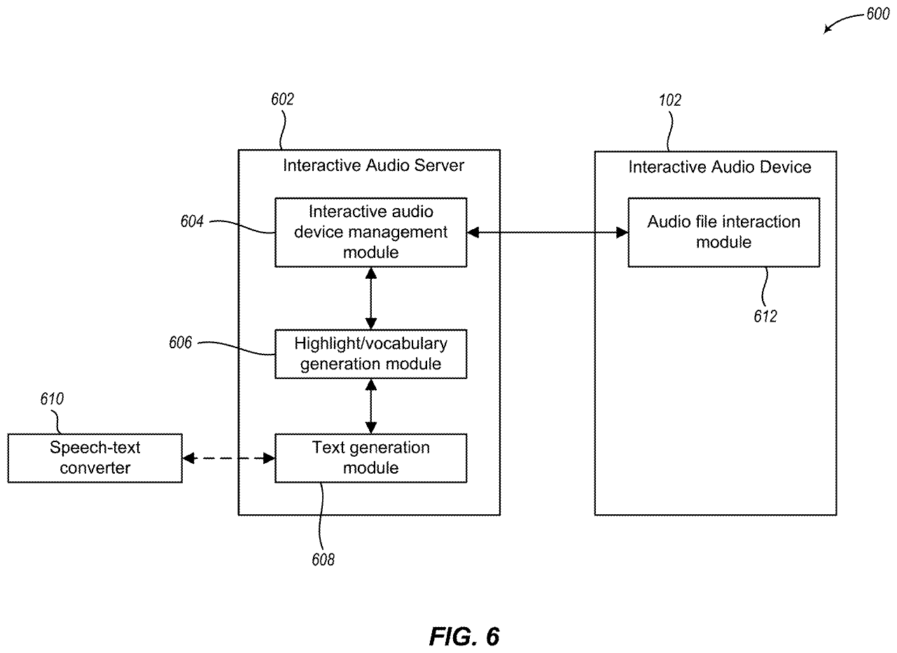

FIG. 6 illustrates a context diagram of yet another example an interactive reading system described herein. System 600 includes an interactive audio server 602, an interactive audio device 102, and optionally a speech-text converter 610. The interactive audio server 602 may be a variation of interactive audio server 402 in FIG. 4. The interactive audio server 602 includes one or more computing devices, such as a server computer, a cloud-based server, or other computing environment. The interactive audio device 102 is a computing device as described herein, but may include different or additional functionality.

The interactive audio device 102 includes an audio file interaction module 612. The audio file interaction module 612 enables a user to record a live lecture or listen to a prerecorded audio file, such as a podcast. The audio file interaction module 612 also allows the user to trigger events to extract highlighted text or vocabulary text, as described herein. The audio file interaction module 612 communicates with the interactive audio server 602 to provide the events and the recorded audio file to the interactive audio server 602. Moreover, the audio file interaction module 612 communicates with the interactive audio server 602 to enable the user to access the extracted highlighted text or vocabulary text as part of an augmented version of the original text file or as a separate notes table or file.

Interactive audio server 602 includes an interactive audio device management module 604, highlight/vocabulary generation module 606, and a text generation module 608. The interactive audio device management module 604 communicates with the interactive audio device 102 to receive the audio file and information regarding the triggered events (e.g., highlight events or vocabulary events and their event time position) identified by the user of the interactive audio device 102 as the user is listing to the audio that is being recorded. The interactive audio device management module 604 provides the received events to the highlight/vocabulary generation module 606.

The highlight/vocabulary generation module 606 splits the audio file based on the event time positions to create separate smaller audio files. The highlight/vocabulary generation module 606 provides the split audio files to the text generation module 608. In some embodiments, the text generation module 608 itself performs speech to text processing. In other embodiments, the text generation module 608 communicates with an external speech-text converter 610. The speech-text converter 610 may be a third party computing system that receives the split audio files and returns separate text files.

The text generation module 608 returns separate text files for each event to the highlight/vocabulary generation module 606. The highlight/vocabulary generation module 606 parses the text files to create extracted text for the event (e.g., highlight text or vocabulary text), which is then added to a notes table or file The interactive audio device management module 604 or the highlight/vocabulary generation module 606 also provides to the interactive audio device 102 access to the notes table or file.

Although FIG. 6 illustrates the interactive audio server 602 as including multiple modules, some embodiments may include one, two, or more, or some combination of modules to perform the functions of the interactive audio server 602. Similarly, although the interactive audio device 102 is illustrated as having a single module, some embodiments may include a plurality of modules to perform the functions of the interactive audio device 102.

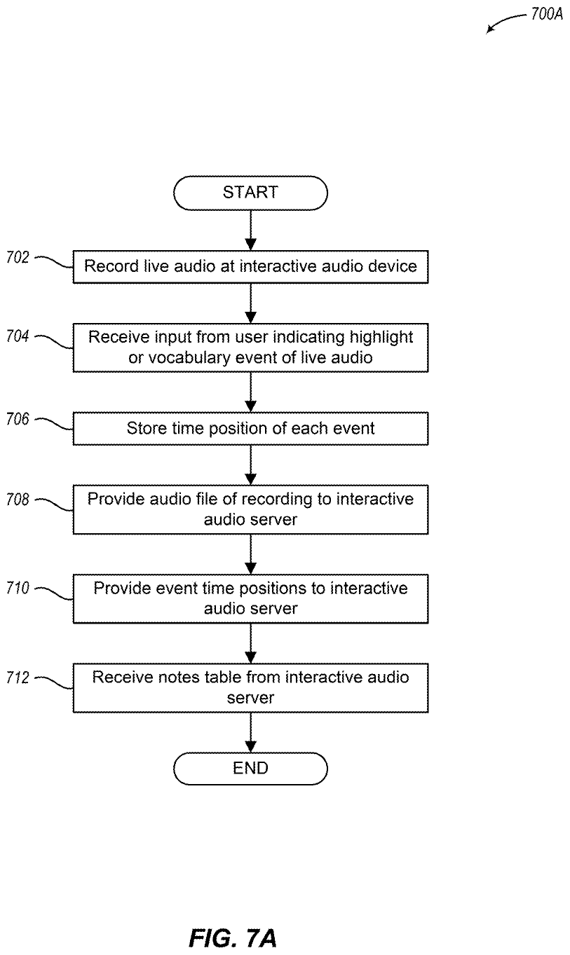

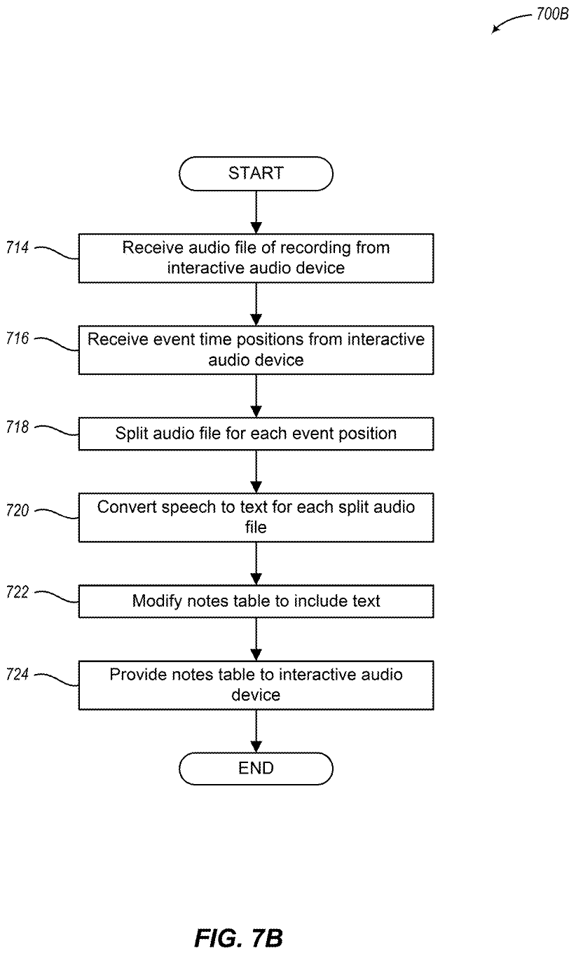

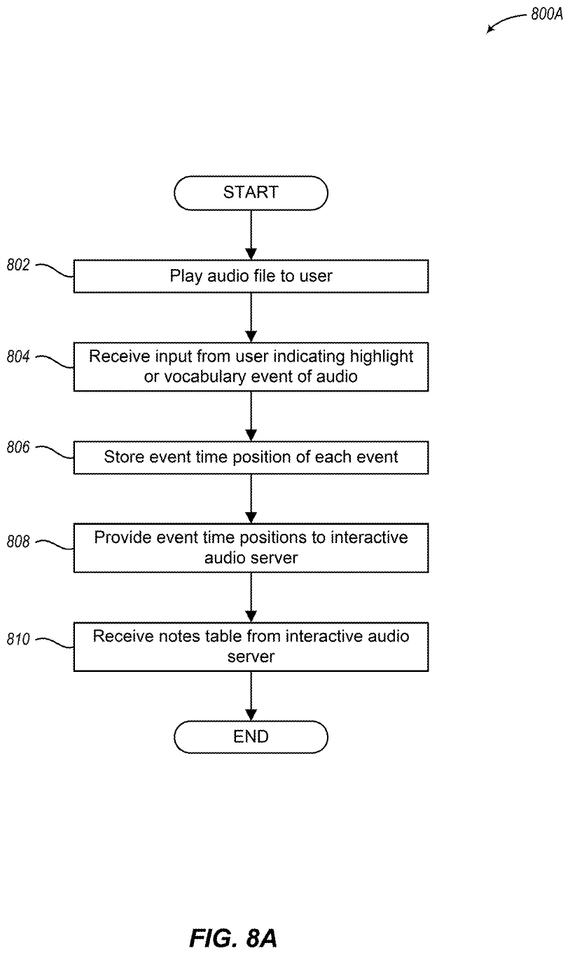

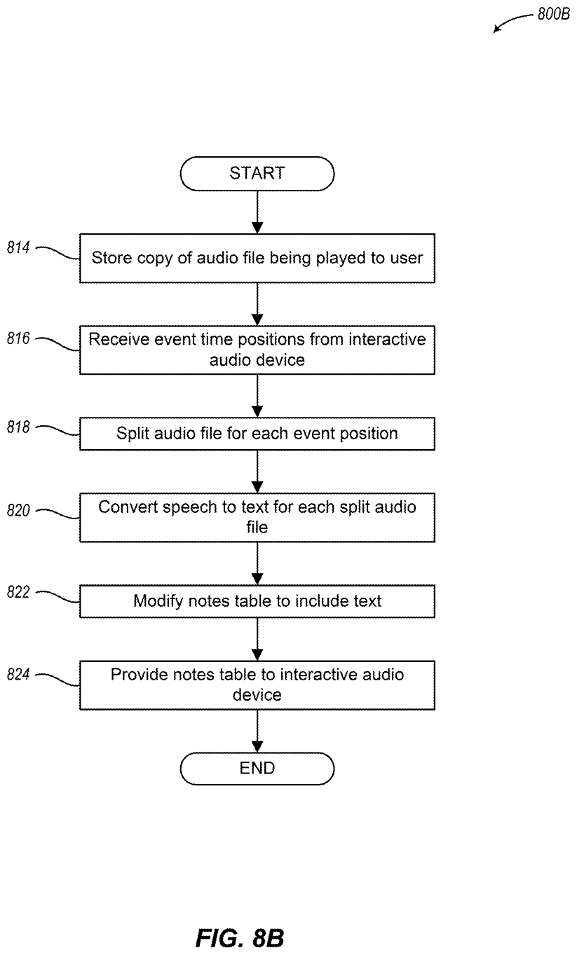

The operation of certain aspects will now be described with respect to FIGS. 7A-7B and 8A-8B. In at least one of various embodiments, processes 700A and 800A in FIGS. 7A and 8A, respectively, may be implemented by or executed on one or more computing devices, such as interactive audio device 102 in FIG. 6 or interactive audio device 102 described in FIG. 9 below, and processes 700B and 800B in FIGS. 7B and 8B, respectively, may be implemented by or executed on one or more computing devices, such as interactive audio server 602 in FIG. 6 or interactive audio server 1002 described in FIG. 10 below.

FIGS. 7A-7B illustrate logical flow diagram generally showing embodiments of processes for an interactive audio device and an interactive audio server to generate a notes table based on user input during a live audio recording described herein. In particular, process 700A in FIG. 7A is performed by the interactive audio device and process 700B in FIG. 7B is performed by the interactive audio server. In general, these processes automate the creation of a separate notes file while listening to and recording a live lecture, which results in the extraction of highlighted sections from a transcript of the lecture and saves to the interactive audio server.

Process 700A begins, after a start block, at block 702, where the interactive audio device records live audio, such as a lecture. In various embodiments, the user of the interactive audio device begins a recording of a live lecture or training session by clicking a record button on the interactive audio device.

Process 700A proceeds to block 704, where input from the user is received indicating a highlight or vocabulary event associated with the live audio. In various embodiments, one or more events may be input throughout the recording of the live audio.

While listening to the speaker and the audio is being recorded, the user may hear a passage or vocabulary word that is noteworthy and want to write it down. Instead of manually writing it down, the user inputs an event command (e.g., a highlight or vocabulary command, as discussed above) when the user wants to capture a transcript of that portion of the lecture. The user can input the event command via a push button interface or a voice-activated event command while the recording is occurring, similar to what is described above.

Process 700A continues at block 706, where a time position associated with each event is stored. When the user clicks the event button (or says “highlight” or “vocabulary” if possible based on the environment) the time of the button press in relation to the recording time is captured. This captured time is the event time position that is stored.

After recording the point in the live event where the user wants to extract information (i.e., capture an event), the interactive audio device can prompt the user to select or enter a tag. As discussed above, this will be an opportunity for the user to categorize the event, which can help to file and recall the event in the notes table in the future. The user can at any time during the recording continue to trigger events when topics, words, or information that is important to the user are heard.

When the speaker is finished, the user clicks a stop recording button to end the recording of the audio.

Process 700A proceeds next to block 708, where the recorded audio file is provided to the interactive audio server. The events, their corresponding event time position, and the recording are sent to the interactive audio server for processing. Each individual event is processed to extract the highlight text or vocabulary text from the recorded audio file.

Process 700A continues next to block 710, where the event time positions are provided to the interactive audio server. In some embodiments, the event time positions are provided to the interactive audio server separate from the recorded audio file. In other embodiments, the event time positions may be included in metadata associated with the recorded audio file.

The interactive audio server generates or modifies a notes table or file with the highlight text or vocabulary that corresponds to each event, which is described in conjunction with process 7B in FIG. 7B below.

After block 710, process 700A proceeds to block 712, where the notes table is received from the interactive audio server. In some embodiments, the interactive audio device sends a request to the interactive audio server to provide the notes table. In other embodiments, the interactive audio server automatically sends the notes table to the interactive audio device.

After block 712, process 700A terminates or otherwise returns to a calling process to perform other actions.

In response to the interactive audio device providing the audio file and the event time positions to the interactive audio server, the interactive audio server performs process 700B in FIG. 7B.

Process 700B begins, after a start block, at block 714, where the recorded audio file is received from the interactive audio device.

Process 700B proceeds to block 716, where the event time positions are received from the interactive audio device.

Process 700B continues at block 718, where the audio file is split into separate audio file for each event position. In various embodiments, the interactive audio server obtains the corresponding text for each event by splitting the audio file into pieces of a predetermined amount of time at each individual event time position. This predetermined amount of time may include a first amount of time before the event time position and a second amount of time after the event time position. For example, if the first event note was triggered at 5:34.35 seconds into the recording, then a 2-minute section of the recording (from 4:04.35 in the recording to 6:04.35), including 30 seconds after the event, is obtained from the audio file. In this way, the interactive audio server can convert smaller amounts of audio that are of interest to the user into text, without having to convert the entire audio file into text. In some other embodiments, the audio file is not split, but the entire audio file is converted to text.

Process 700B proceeds next to block 720, where each split audio file is analyzed and the speech is converted to text. In various embodiments, the interactive audio server may perform the speech to text recognition. In other embodiments, the interactive audio server may employ a third party computing system to convert the speech into text. This speech to text processing of each split audio file extracts the text of the obtained portion for each separate event.

Process 700B continues next at block 722, where the notes table is created or modified to include the text for each event, similar to block 516 in FIG. 5.

In some embodiments, after extracting the text, the text may be parsed to identify beginning and endings of sentences or specific vocabulary words. For example, the last complete sentence and the two sentences before the event time position are identified as being associated with the event (e.g., a highlight event). The three sentences are then saved to the note table, with the category the user tagged the event with, the type of event, the date, time, user ID and the title of the lecture, similar to what is described above. The extracted text or vocabulary words from the lecture can them be retrieved later by the user.

In various embodiments, a text version of the entire recorded audio file may be generated, such as by using speech to text processing. The text version may be augmented, as described above to modify the text based on the received event. For example, the text in the text version that corresponding to a highlight event may modify the format of the text to be highlighted, as discussed herein. In this way, a full text version of the audio file can be generated and provided to the user, which also includes format changes that match the user's event input.

Process 700B proceeds to block 724, where the notes table is provided to the interactive audio device, similar to block 518 in FIG. 5.

After block 724, process 700B terminates or otherwise returns to a calling process to perform other actions.

Processes 700A and 700B in FIGS. 7A-7B illustrate embodiments where the user is inputting a highlight or vocabulary event during a live recording of the audio by the interactive audio device. In some embodiments, however, the audio file may have been previously recorded and stored on the interactive audio serve.

FIGS. 8A-8B illustrate logical flow diagram generally showing an alternative embodiment of processes for an interactive audio device and an interactive audio server to generate a notes table based on user input while listening to a previously recorded audio file described herein. In particular, process 800A in FIG. 8A is performed by the interactive audio device and process 800B in FIG. 8B is performed by the interactive audio server. These processes describe automation of the creation of a separate notes file while listening to a podcast or other pre-recorded audio file, while extracting and saving transcript or vocabulary from the highlighted sections of the podcast.

Process 800A begins, after a start block, at block 802, where an audio file is played to the user of the interactive audio device. An example of such an audio file may be a podcast recording. Unlike process 500 in FIG. 5, where the interactive audio device receives the audio file from the interactive audio server, process 800A obtains the audio file from a third party computing system, or from the interactive audio server. A user of the interactive audio device selects a podcast to listen to from the podcast menu to begin.

Process 800A proceeds to block 804, where input from the user is received indicating a highlight or vocabulary event associated with the audio file. In various embodiments, block 804 may employ embodiments of block 704 in FIG. 7 to receive event inputs from the user.

For example, while listening to the podcast, a user may hear some item of information or technical details that they want to remember. But they may be on a bus or driving their car and unable to write it down. To highlight or extract that information of interest, the user can speak an event command (e.g., “highlight that” or “save word”) or click a button on a display screen to highlight a sentence or extract a vocabulary word, similar to what is described above.

The interactive audio device may pause playback and prompt the user to confirm the event command. After the user has confirmed the event, the interactive audio device may prompt the user to select or enter a tag. As described above, the tag provides the user with an opportunity to categorize the note, to help file and recall the event in the note table in the future.

The user can at any time during the playback of the podcast trigger an event when topics, words, or information that is important is heard.

Process 800A continues at block 806, where a time position associated with each event is stored. In various embodiments, block 806 may employ embodiments of block 706 in FIG. 7 to store event time positions.

Process 800A proceeds next to block 808, where the event time positions are provided to the interactive audio server, similar to block 710 in FIG. 7. In some embodiments, a name, identifier, or location (e.g., a URL) of the audio file is provided to the interactive audio server along with the event time positions.

In some embodiments, the interactive audio device sends each separate event time position and corresponding event information in the podcast to the interactive audio server as the user confirms the events. In other embodiments, the interactive audio device waits to send the event time positions to the interactive audio server until after the podcast has finished.

The interactive audio server processes each individual event to extract the text from the audio and generates or modifies a notes table with the highlight text or vocabulary that corresponds to each event, which is described in conjunction with process 8B in FIG. 8B below.

After block 808, process 800A proceeds to block 810, where the notes table is received from the interactive audio server. In various embodiments, block 810 may employ embodiments of block 712 in FIG. 7 to receive the notes table from the interactive audio server.

After block 810, process 800A terminates or otherwise returns to a calling process to perform other actions.

In response to the interactive audio device providing the event time positions to the interactive audio server, the interactive audio server performs process 800B in FIG. 8B.

Process 800B begins, after a start block, at block 814, where the a copy of the audio file being listened to by the user is stored. In some embodiments, the audio file may be stored prior to the user listening to the audio file. In other embodiments, the interactive audio server may obtain a copy of the audio from a third party computing device after the event time positions are received from the interactive audio device.

Process 800B proceeds to block 816, where the event time positions are received from the interactive audio device. In various embodiments, block 816 may employ embodiments of block 716 in FIG. 7 to receive the event time positions.

Process 800B continues at block 818, where the audio file is split into separate audio file for each event position. In various embodiments, block 818 may employ embodiments of block 718 in FIG. 7 to split the audio file for each separate event position. For example, if the first event was triggered at 5:34.35 seconds into the recording, a predetermined amount of time (before or before and after) the recording (e.g., from 4:04.35 in the recording to 6:04.35) is obtained.

Process 800B proceeds next to block 820, where each split audio file is analyzed and the speech is converted to text. In various embodiments, block 820 may employ embodiments of block 720 in FIG. 7 to convert the speech to text.

Process 800B continues next at block 822, where the notes table is created or modified to include the text for each event. In various embodiments, block 822 may employ embodiments of block 722 in FIG. 7 to create or modify the notes table. In various embodiments, once the text of the audio portion is determined from the split audio files, the text is parsed to identify each sentence or a particular vocabulary word. The last complete sentence and one or two (or other number) sentences before the last complete sentence may be extracted. These extracted sentences are then save to the note database, along with the category the user tagged the event with, the date, time, user ID and the title of the lecture, as discussed above. The extracted text of the podcast can them be retrieved later by the user.

Process 800B proceeds to block 824, where the notes table is provided to the interactive audio device. In various embodiments, block 824 may employ embodiments of block 724 in FIG. 7 to provide the notes table to the interactive audio device.

After block 824, process 800B terminates or otherwise returns to a calling process to perform other actions.

Embodiment described above may also be utilized to automate the creation of a separate notes file while viewing a PDF by simply highlighting text, which can extract text from the highlighted sentences in the book and saved to a note database, such as via a web-based interface. For example, when a user is reading a book (e.g., a text book), the user may want to highlight a sentence or two in the book for later reference. Highlighting using the mouse will act as any highlight feature, with the added benefit that the sentence will also be extracted and added to the notes file for the book they are reading.

In various embodiments, such functionality may be obtained by presenting a text book to the user, so that the user can read (not listen) to the book. The user can identify a passage they want to remember and reference later. The user clicks with her or his mouse and selects one or more sentences of interest, and then clicks a highlight button. The selected sentences are then highlighted with a different color (e.g., yellow). The user may be presented with a dialog box prompting the user to input a tag. As described above, the tag allows the user to categorize the highlighted text. Once the text is selected, the system extracts the highlighted words and stores them, along with any user-provided tags, into the notes database. Having the text extracted into the notes database along with the category tag, allows the user to later sort, filter and search the extracted notes separate from the original text or audio file. For example, after the user is done reading a book, the user can filter all notes taken from the book that were tagged with Politics. This would allow the user to quickly read excerpted text from the book tagged with Politics.

In yet other embodiments, the system described herein may be employed to view highlighted text added by an interactive audio device (e.g., a mobile device) when viewing a document in a Web Viewer. In this example, the system automatically highlights sentences in the PDF that were tagged by the user. For example, while a user is listening to audio text, the user may be highlighting one or more sentences to be extracted and saved in a notes database, as described herein. At some later time after the user has listened to the book on the interactive audio device and highlighted one or more sentences (e.g., by voice command or tapping the highlight button, as described herein), the user can open a PDF document version of that same book, via a web browser or on the interactive audio device. They system utilizes the notes database to identify the previously stored highlights associated with that book and their corresponding position in the book. With this information, the system highlights the corresponding sentences in the book so that the user sees which sentences the user “highlighted” while listening to the book. The system may also present any tag categories associated with the sentence and any dictated notes the user gave via voice dictation, such tags and dictated notes may be presented in the margins, as embedded objects that expand or open additional windows with the tags or dictation, or via other visual notes.

FIG. 9 shows a system diagram that describes one implementation of computing systems for implementing embodiments described herein. System 900 includes interactive audio device 102. As mentioned above, interactive audio device 102 is a computing device such as a smart phone, tablet computer, laptop computer, desktop computer, automobile head unit, stereo system, or other computing device.

Interactive audio device 102 enables a user to interact with and augment text that is being presented to the user via an audible reading of the text, as described herein. One or more special-purpose computing systems may be used to implement interactive audio device 102. Accordingly, various embodiments described herein may be implemented in software, hardware, firmware, or in some combination thereof. Interactive audio device 102 includes memory 930, one or more central processing units (CPUs) 944, display 946, audio interface 948, other I/O interfaces 950, other computer-readable media 952, and network connections 954.

Memory 930 may include one or more various types of non-volatile and/or volatile storage technologies. Examples of memory 930 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 930 may be utilized to store information, including computer-readable instructions that are utilized by CPU 944 to perform actions, including embodiments described herein.

Memory 930 may have stored thereon interactive reading system 222, which includes text interaction module 206 and text 216. The text 216 is a data store of one or more text documents or files, comments associated with those documents, or other augmentations provided by the user. The text interaction module 206 may employ one or more modules to implement embodiments described herein to process commands provided by a user to read text and interact with or augment the text during the reading of the text. In this illustration the text interaction module 206 includes a text request module 208, a text modifier module 210, a comment module 212, and an audio reader module 214. The text request module 208 interacts with text 216 to request and receive text for a user. The text modifier module 210 interacts with text 216 to modify the text based on one or more formatting interactions received from the user. The comment module 212 interacts with text 216 to store audio comments and their associated position in the text. And the audio reader module 214 reads or otherwise outputs the audio version of the text to the user.

Memory 930 may also store other programs 938 and other data 940.

Audio interface 948 may include speakers, e.g., speaker 120, to output audio signals of the audio text being read. The audio interface 948 may also include a microphone, e.g., microphone 118, to receive commands or comments from the user. The audio interface 948 can then coordinate the recording of comments or the augmentation of the text with the text interaction module 206. In some embodiments, the audio interface 948 may be configured to communicate with speaker(s) or microphone(s) that are separate from the interactive audio device 102.

Display 946 is configured to display information to the user, such as an identifier of the current text being read to the user or a current reading position therein. In some embodiments, the display may include scrolling text or images of the text that is being read. In various embodiments, these images may be updated as the user is providing comments or augmenting the text. For example, if a user provides a command to highlight the last ten words, then the text may be modified to include the highlighted text and the display may be updated to show the modified text.

Network connections 954 are configured to communicate with other computing devices (not illustrated), via a communication network (not illustrated). For example, in some embodiments, the interactive audio device 102 may communicate with one or more remote servers to access additional text documents or files, audio versions of text, or other information.

Other I/O interfaces 950 may include a keypad, other audio or video interfaces, or the like. Other computer-readable media 952 may include other types of stationary or removable computer-readable media, such as removable flash drives, external hard drives, or the like.

In various embodiments, the interactive audio device 102 may communicate with a remote control 960 to receive commands from the user to interact with the audio text. The remote control 960 is a physical device with one or more physical buttons that communicate with the interactive audio device 102 to enable a user to send commands from the remote control 960 to the interactive audio device 102. The remote control 960 may communicate with the interactive audio device 102 via Bluetooth, Wi-Fi, or other wireless communication network connection, or they may communicate via a wired connection.

In at least one embodiment, the remote control 960 sends radio frequency signals to the interactive audio device 102 identifying which button on the remote control 906 was depressed by the user. The interactive audio device 102 receives those radio frequency signals and converts them into digital information, which is then utilized to select the command that corresponds to the button that was pressed by the user. In various embodiments, the interactive audio device 102 includes a user interface that enables the user to select or program which buttons on the remote control 960 correspond to which commands to interact with the audio text. Once programmed, the user can interact with the audio text via the remote control 960.

Such a remote control may be built into another component, such as a steering wheel of an automobile and communicate with the head unit of the automobile or the smartphone of the user, or it may be a separate device that is sized and shaped to be handheld or mounted to another component, such as the steering wheel of the automobile. In this way, the user can quickly press a button on the remote control 960 to input the command to interact with the audio text, as described herein.

FIG. 10 shows a system diagram that describes one implementation of computing systems for implementing embodiments of an interactive audio server described herein. System 1000 includes interactive audio server 402.

Interactive audio server 402 communicates with interactive audio device 102 (not illustrated in this figure), such as in FIG. 4 or 6, to provide hands-free text extraction and note taking while audio is being presented to the user, as described herein. One or more special-purpose computing systems may be used to implement interactive audio server 402. Accordingly, various embodiments described herein may be implemented in software, hardware, firmware, or in some combination thereof. Interactive audio server 402 includes memory 1030, one or more central processing units (CPUs) 1044, display 1046, other I/O interfaces 1050, other computer-readable media 1052, and network connections 1054.

Memory 1030 may include one or more various types of non-volatile and/or volatile storage technologies similar to memory 930 of the interactive audio device 102 in FIG. 9. Memory 1030 may be utilized to store information, including computer-readable instructions that are utilized by CPU 1044 to perform actions, including embodiments described herein.

Memory 1030 may have stored thereon interactive reading system 1016, which includes interactive audio device management module 1004, highlight/vocabulary generation module 1006, and audio/text generation module 1008. The interactive audio device management module 1006 communicates with an interactive audio device 102 to provide or receive audio files to or from the interactive audio device 102, to receive highlight events from the interactive audio device 102, and to enable the interactive audio device 102 to access highlight or vocabulary notes generated by the interactive audio server 402. The highlight/vocabulary generation module 1006 generates highlighted text or vocabulary text from text versions of audio being listened to by a user. The audio/text generation module 1008 performs various audio-to-text conversions or text-to-audio conversions based on the embodiment. In some embodiments, the audio/text generation module 1008 may not perform these conversions, but may communicate with a third party computing device that performs the conversions.

The interactive reading system 1016 may also include text 1010, audio 1012, and notes 1014. The text 1010 is a data store of one or more text documents or files, comments associated with those documents, or other augmentations provided by the user. The audio 1012 is a data store of one or more audio files. And the notes 1014 is a data store of one or more highlight or vocabulary notes extracted from the text 1010 or the audio 1012 based on user input, as described herein. The notes 1014 may be a notes table or some other data structure.

Memory 1030 may also store other programs 1038 and other data 1040.

Display 1046 may be configured to display information to the user or an administrator, such as notes or text generated by the interactive audio server 402. Network connections 1054 are configured to communicate with other computing devices (not illustrated), via a communication network (not illustrated), such as interactive audio device 102 (not illustrated). Other I/O interfaces 1050 may include a keypad, other audio or video interfaces, or the like. Other computer-readable media 1052 may include other types of stationary or removable computer-readable media, such as removable flash drives, external hard drives, or the like.

The various embodiments described above can be combined to provide further embodiments. This application also claims the benefit of U.S. Provisional Patent Application No. 62/481,030, filed Apr. 3, 2017 and U.S. Provisional Patent Application No. 62/633,489, filed Feb. 21, 2018, and are incorporated herein by reference in their entirety. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computing device, comprising:
a speaker to output audio signals;
a microphone to receive audio signals;
a memory that stores instructions and text; and
a processor that executes the instructions to:
receive a first command from a user to read the text;
determine a start position for reading the text;
output, via the speaker, an audio reading of the text to the user beginning at the start position;
receive a second command from the user to provide a comment;
record, via the microphone, the comment provided by the user at a current reading position in the text;
receive a third command from the user to format the text, wherein the third command is a voice command received via the microphone;
modify at least one format characteristic of at least a portion of the text based on the third command received from the user;
receive a fourth command from the user to modify the current reading position in the text; and
output, via the speaker, the audio reading of the text to the user from the modified reading position.

2. The computing device as recited in claim 1, wherein the first command is a voice command received via the microphone from the user to initiate the audio reading of the text.

3. The computing device as recited in claim 1, wherein the start position for reading the text is identified in the first command.

4. The computing device as recited in claim 1, wherein the second command is a voice command received via the microphone from the user to input an audible comment.

5. The computing device as recited in claim 1, wherein the fourth command is a voice command received via the microphone to modify the current reading position in the text.

6. The computing device as recited in claim 1, wherein the processor executes the instructions to further:
generate a new text file to include at least one of: a text version of the comment provided by the user, the portion of the text with the modified at least one format characteristic, or a text version associated with the at least one format characteristic; and
provide the new text file to the user.

7. A method, comprising:
converting text to an audio version and a plurality of speech marks;
providing the audio version to a user device;
receiving at least one highlight or vocabulary event from the user device, the at least one highlight or vocabulary event includes an event time position associated with the audio file;
determining at least one note from the text based on the event time position and the plurality of speech marks;
generating a document with the at least one note; and
providing the document to the user device.

8. The method as recited in claim 7, further comprising:
receiving the text or a selection of the text from the user device.

9. The method as recited in claim 7, wherein receiving the at least one highlight or vocabulary event includes receiving a voice command from a user of the user device to obtain a portion of the text for the document.

10. The method as recited in claim 7, wherein determining the at least one note includes:
identifying a time in the plurality of speech marks that matches the event time position;
determining a text position in the text that corresponds to the identified time; and
generating the at least one note based on an identified number of sentences or an identified word in the text associated with the determined text position.

11. A system, comprising:
a user device that includes:
a microphone to receive audio signals;
a first memory that stores first instructions;
a first processor that executes the first instructions to:
record an audio file via the microphone
receive an input from a user identifying at least one highlight or vocabulary event associated with the audio file; and
determining an event time position associated with each of the at least one highlight or vocabulary event; and
a server device that includes:
a second memory that stores second instructions; and
a second processor that executes the second instructions to:
receive the audio file from the user device;
receive the at least one highlight or vocabulary event associated with the audio file from the user device;
split the audio file into separate audio files for each of the at least one highlight or vocabulary event based on the event time position for each of the at least one highlight or vocabulary event;
convert the separate audio files into separate text files;
determine at least one note for each separate text file;
generate a document with the at least one note; and
provide the document to the user device.

12. The system as recited in claim 11, wherein the input received from the user identifying the at least one highlight or vocabulary event is received as a voice command via the microphone.

13. The system as recited in claim 11, wherein the second processor executes the second instructions to further:
receive a tag provided by the user of the user device identifying a category associated with the at least one highlight or vocabulary event; and
modify the at least one note to include the tag.

14. The system as recited in claim 11, wherein the second processor executes the second instructions to further:
generate a text version of the audio file;
augment the text version based on the at least one highlight or vocabulary event; and
provide the augmented text version to the user device.

15. The system as recited in claim 11, wherein the splitting of the audio file into separate audio files for each of the at least one highlight or vocabulary event includes generating a new audio file for each of the at least one highlight or vocabulary event to include a first portion of time prior to a corresponding event time position and a second portion of time after the corresponding event time position.
